(19) United States
(12) Patent Application Publication
(10) Pub. No.: US 2012/0112104 A1
(43) Pub. Date: May 10, 2012

(54) ACTUATOR FOR CONTROLLING A FLUID FLOW

(75) Inventors: JOERG KIESBAUER, EPPERTSHAUSEN (DE); THOMAS KARTE, BRUCHKOEBEL (DE); RUDOLF LAESSLER, MAINTAL (DE); KLAUS HOERSCHKEN, VILLMAR (DE)

(73) Assignee: SAMSON AG, FRANKFURT AM MAIN (DE)

(21) Appl. No.: 13/246,837

(22) Filed: Sep. 27, 2011

(30) Foreign Application Priority Data
Sep. 30, 2010 (DE) 102010037897.6-12

(51) Int. Cl. F16K 31/02

(52) U.S. Cl. 251/129.01

(57) ABSTRACT

The invention relates to an actuator (10) for controlling a fluid flow comprising a basic housing (12a) having an inlet (14) and an outlet (16), a valve seat (18) provided in the basic housing (12) between said inlet and said outlet (14, 16), a valve body (20) that can be operatively connected to the valve seat (18), a valve rod (22) for actuating said valve body (20) as well as means for actuating the valve rod (22). The invention is characterized in that an additional housing (12b) is mounted on said basic housing (12a) in a fluid tight manner and that the basic and additional housings (12a, 12b)—with the exception of the inlet and outlet (14, 16) form a completely sealed housing (12) that is closed on all sides and only includes one circumferential seal (24), and that said valve rod (22) is completely disposed inside said sealed housing (12) without any passage.

This application claims priority to, and benefit of, German patent application number: 10 2010 037 897.6-12, filed on Sep. 30, 2010. German patent application number: 10 2010 037 897.6-12, filed on Sep. 30, 2010, in incorporated herein by reference hereto the same as if rewritten herein verbatim.

The invention relates to an actuator for controlling a fluid flow.

The process industry uses actuators for controlling fluid flows which are normally not to enter the surrounding atmosphere. As far as design is concerned, the so-called “dynamic seals” should above all be noted here. A dynamic seal is used for sealing passages in a valve housing for example through which translational or rotational movements are introduced into the valve housing via a shaft. The shaft is used to move the valve body, and varying the position of the valve body will result in the respective desired restriction effect. As dynamic seals are subject to wear and tear and other mechanisms, this may result in process fluid leaking into the surrounding atmosphere.

Actuators of this kind are well known in the prior art. Merely by way of example, reference is made to document DE 10 2006 061 017 A1.

It is the object of the invention to further improve an actuator for controlling a fluid flow so as to reduce the danger of leakage, and thus of process fluid being released into the surrounding atmosphere, and to avoid the aforementioned shortcomings.

As is generally known, the actuator for controlling a fluid flow comprises a basic housing having an inlet and an outlet. Mounted between the inlet and the outlet in the basic housing is a valve seat. Furthermore, the actuator comprises a valve body that can be operatively connected to the valve seat as well as a valve rod for actuating said valve body and means for actuating said valve rod.

According to the invention, an additional housing is mounted on said basic housing in a fluid tight manner and such that said basic and additional housings—with the exception of the inlet and outlet—form a completely encapsulated or sealed housing which is closed on all sides and has just one circumferential seal, in which the valve rod is disposed without a passage, i.e. it completely extends inside the sealed housing.

The inventive design, in which the basic and additional housings are formed as a sealed housing, as well as the inventive passage-free mounting of the valve rod inside the closed housing advantageously provides an actuator which no longer has respective dynamic seals for sealing a valve rod that extends into the valve housing, thus eliminating the danger of leakage due to a damaged dynamic seal.

Preferably the means for actuating the valve rod is mounted outside the sealed housing and is operatively connected to the valve rod in a non-contact manner. Consequently, the housing does not have any further aperture for the valve rod drive—which additionally reduces the danger of leakage.

The means for actuating the valve rod is preferably designed such that it will actuate the valve rod by means of a magnetic and/or an electromagnetic force.

In a first embodiment of the invention, the valve rod includes an iron core or a magnet for this purpose, with an external magnet being disposed outside the sealed housing, which magnet can be displaced relative to the housing. Suitably moving the external magnet relative to the housing will allow the non-contact actuation of the valve rod to be initiated. This embodiment of the means for actuating the valve rod is characterized particularly by its simple design and its reliability.

In another embodiment of the invention, the valve rod again includes an iron core or a magnet, with an electromagnet being firmly mounted on and outside of the sealed housing. By changing the current flow through the electromagnet, a varying force will be exerted on the valve rod through which the non contact actuation of the valve rod can be controlled. The use of an electromagnet firmly mounted on the housing turns out to be advantageous since eliminating any relative movement between an external magnet and the housing will allow a simplified structure to be accomplished.

In a particularly advantageous embodiment of the actuator, the valve body is operatively connected to a drive disposed within the sealed housing, which drive is supplied with fluid flowing through said actuator. This turns out to be advantageous since it reduces the actuating force of the means for actuating the valve rod.

Basically, prior art fluid-operated drives can also be used, both of the pneumatically and of the hydraulically actuated type. Considered advantageous is the use of a linear drive, and swivel drives can basically also be envisaged provided that their movement will be suitably converted. For controlling the drive, a prior art fluid actuated positioner mounted within the sealed housing may basically be conceived. The positioner would detect the position of the valve body and perform a suitable positioning action.

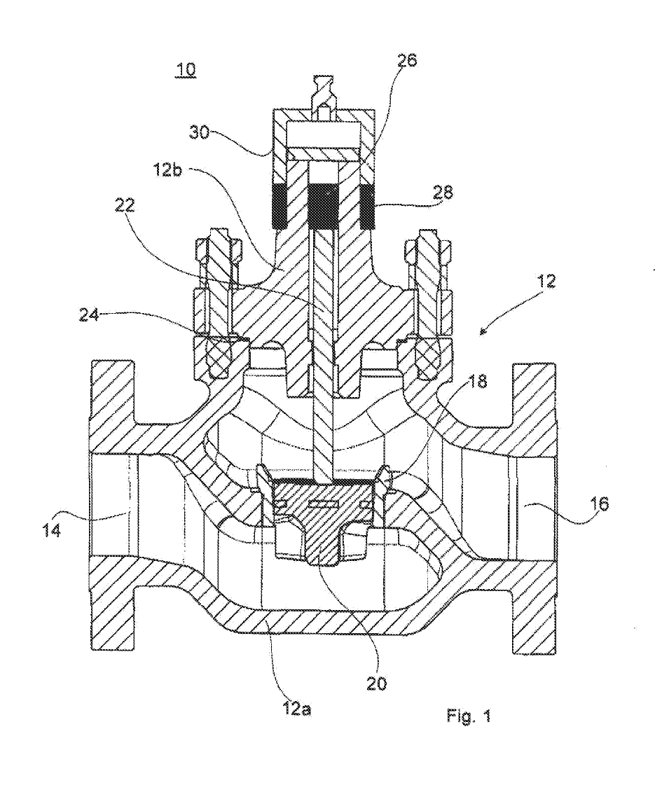

One possible example of a positioner of this type is shown in FIG. 1 of DE 28 47 380 A1. For this example, lever 5 would have to be provided with a magnet whose impinging force is controlled by a device mounted outside said housing, as described above. The fluid entering into the valve inlet of the actuator according to the invention would impinge on inlet 8. Inlet 3 would be dispensed with; the fluid exiting nozzle 7 would suitably be supplied to the valve outlet of the actuator according to the invention.

Basically, fluid driven electronic positioners are also conceivable, also of the type having diagnostic means.

In one embodiment of the invention, the valve rod is completely guided within said housing, and the valve body is partly guided therein, with first and second chambers being formed between the valve body and the valve rod, which chambers are in fluid communication with each other via a through bore. In this design, the first chamber which is associated with the valve body is in fluid communication with the inlet via a through bore in the valve body, and the second chamber which is associated with the valve rod is in fluid communication with the outlet. Furthermore, the valve rod is disposed and designed such that the through hole between the first and second chambers can be opened and closed by actuating the valve rod.

Preferably the valve body is spring-biased when guided within said housing. This ensures that the valve body will be returned in a simple manner.

In order to provide sufficient excess force and thus sufficient force action, the through hole is larger in diameter than the through bore.

According to yet another embodiment of the invention, the valve rod is spring-biased by a spring element when guided within the sealed housing.

According to yet another embodiment of the invention which is considered particularly advantageous, a main valve is connected upstream of said actuator. In accordance with said actuator, the main valve comprises basic and additional housings, said basic housing having an inlet and an outlet as well as a valve seat provided between said inlet and said outlet, and said additional housing including a valve body that can be operatively connected to said valve seat as well as a balancing chamber having an outlet opening. Moreover, portions of said valve body are spring-biased when guided within the additional housing, and the balancing chamber is in fluid communication with the inlet of the main valve via a through bore in the valve body. The actuator which functions as a pilot stage has its inlet in fluid communication with the outlet opening of the main valve, and its outlet is in fluid communication with the outlet of the main valve. Furthermore, both the through bore in the valve body of the actuator and the through hole between the first and second chambers of the actuator are smaller in diameter than the through bore in the valve body of the main valve and the outlet opening of the balancing chamber of the main valve. As the pressure in the inlet of the actuator is equal to the input pressure of the main valve, the actuator has the same power as the main valve. Furthermore, as the flow is controlled by the main valve and the cross-sectional dimensions were suitably chosen, the actuating force which needs to be applied by the means for actuating the valve rod of the actuator will thus be clearly reduced in an advantageous way.

Further advantages, features and possible applications of the present invention will become obvious from the description which follows, in combination with the embodiments illustrated in the drawings.

Throughout the description, claims and drawings, such terms and associated reference numerals will be used as are listed in the list of reference numerals below. In the drawings,

FIG. 1 is a view of a first embodiment of the actuator according to the invention;

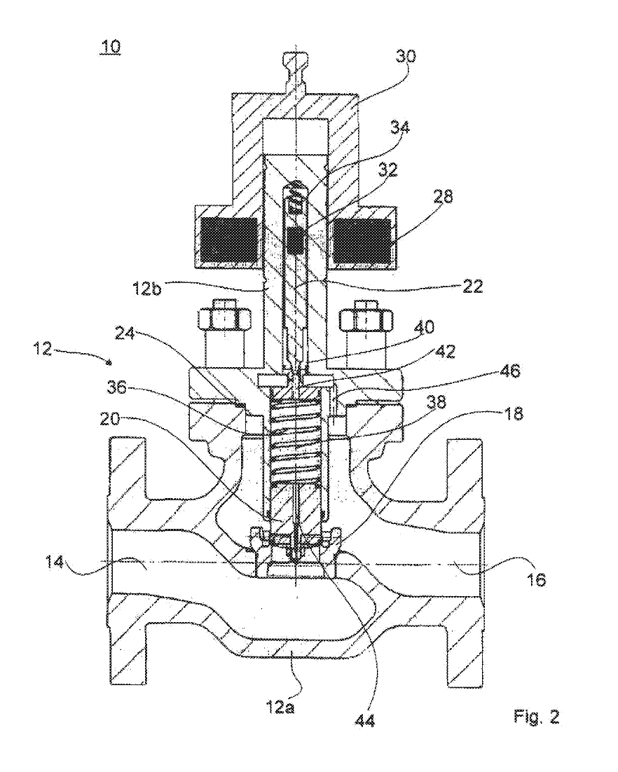

FIG. 2 is a view of a second embodiment of the actuator according to the invention;

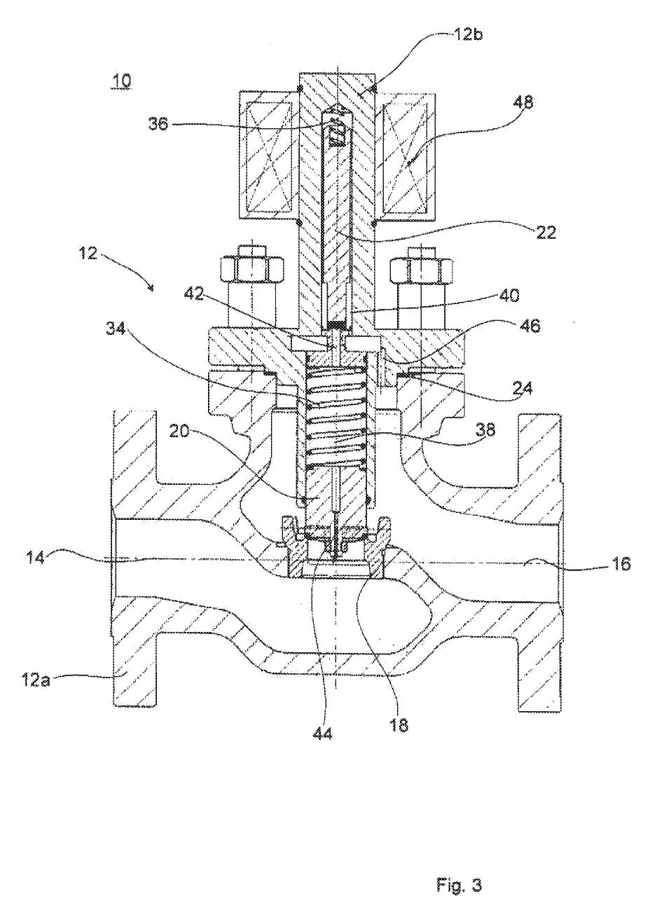

FIG. 3 is a view of a third embodiment of the actuator according to the invention;

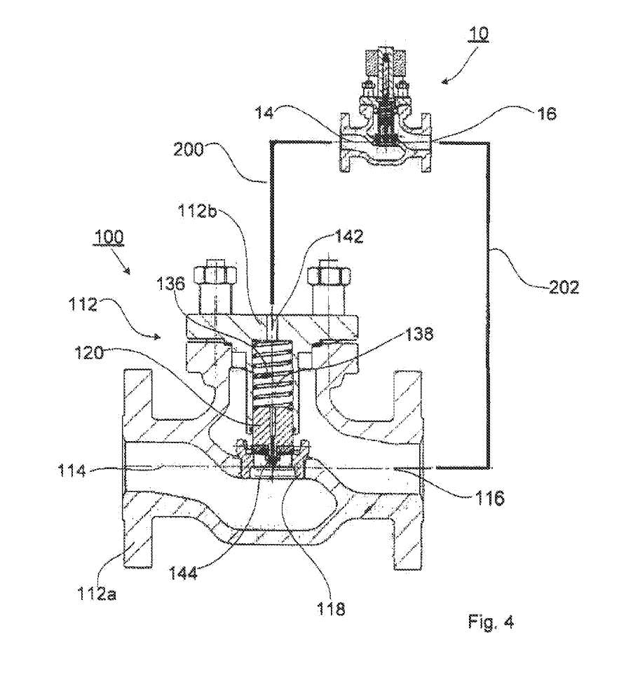

FIG. 4 illustrates the use of the actuator according to the invention as a pilot stage for a main valve.

In the description below and in the drawings, identical parts and components also bear the same reference numerals in order to avoid repetitions, as long as no further differentiation is required or expedient.

FIG. 1 is a more or less schematic view of an actuator marked 10 for controlling a fluid flowing through said actuator 10. The actuator 10 comprises a basic housing 12a having an inlet 14 and an outlet 16. Provided between said inlet 14 and said outlet 16 is a valve seat 18.

Moreover, the actuator 10 comprises a valve body 20 which is in turn connected to a valve rod 22. A stroke movement of the valve rod 22 can be used for controlling the flow between the valve body 20 and the valve seat 18. The respective means for actuating the valve rod 22 will be described in the course of the description.

The actuator 10 furthermore comprises an additional housing 12b. As can clearly be seen in FIG. 1, the additional housing 12b is mounted on the basic housing 12a in a fluid tight manner and in such a way that the basic and additional housings 12a, 12b—except for inlet and outlet 14, 16—will form a completely sealed housing 12 which is closed on all sides and only includes one circumferential seal 24.

As may further be seen in FIG. 1, the additional housing 12b is moreover designed such that the valve rod 22 is completely disposed within the sealed housing 12 without any passage.

The already mentioned means for actuating the valve rod in the present case comprises a magnet 26 which is firmly connected to the valve rod 22 as well as an external magnet 28 located outside the housing 12, which external magnet 28 is in turn mounted on a frame element 30 which allows it to be displaced relative to the housing 12. Consequently, movement of said frame 30 and thus of said external magnet 28 relative to said housing 12 will allow said valve rod 22 to be moved without any contact.

In accordance with the already described first embodiment of FIG. 1, also in the second embodiment shown in FIG. 2 the means for actuating the valve rod is again provided in the form of an external magnet 28 which is disposed outside the housing 12 and can be displaced relative to the housing 12 by means of a frame 30. In contrast to the first embodiment of FIG. 1, however, the valve rod 22 of the second embodiment is firmly connected to an iron body 32 so that movement of said frame 30 relative to the housing 12 will in turn allow non-contact movement of the valve rod 22.

Furthermore, as may be gathered from FIG. 2, the additional housing 12b is designed such that the valve rod 22 is completely guided within said additional housing 12b and the valve body 20 is partly guided within said additional housing 12b. In this case, the valve rod 22 is spring-biased by a spring 34 as it is guided within said additional housing 12b and the valve body 20 is spring-biased by a spring 36 as it is guided within said additional housing 12b.

Moreover, provided between said valve body 20 and said valve rod 22 are first and second chambers 38 and 40, respectively, which are in fluid communication with each other via a through hole 42. Whereas the first chamber 38 is in fluid communication with the inlet 14 via, a through bore 44 provided in the valve body 20, the second chamber 40 is in fluid communication with the outlet 16 via a bore 46.

As may further be gathered from FIG. 2, the valve rod 22 is disposed and designed in such a way that the through hole 42 between the first and second chambers 38, 40 can be opened and closed by actuating said valve rod 22.

As will become obvious from the following consideration, this will diminish the force required for actuating the valve rod 22. For pressure relief, the fluid will be supplied to the first chamber 38 via, the through bore 44 in the valve body 20 and thus to the rear of the valve body 20. Consequently, no forces will act on the valve body 20. In this state, the valve body 22 will be pressed into the valve seat 18 by the full force of the spring 36. Movement of the valve body 20 may now be accomplished by reducing the pressure acting on the top of the valve body 20. For this purpose, the through hole 42 between the first and second chambers 38, 40 will be opened by a movement of the valve rod 22. As a result, fluid may flow from the first chamber 38 via the through hole 42 to the second chamber 40 and from there to the outlet 16 via the bore 46. In this case, the ratio of the through hole 42 to the through bore 44 has been chosen such that the through hole 42 will allow a clearly larger flow therethrough so that—with the through hole 42 completely open—an almost complete depressurization above said valve body 20 may be accomplished.

The third embodiment of the invention shown in FIG. 3 essentially corresponds to the second embodiment as shown in FIG. 2. In contrast to the second embodiment of FIG. 2, however, the third embodiment merely features a different design of the means for actuating the valve rod.

The valve rod 22 is again firmly connected to an iron core 32 or an internal magnet 26. Outside said housing 12, an electromagnet 48 is firmly connected to the housing. Varying the current flow will cause the electromagnet 48 to exert a different force on the valve rod 22.

As shown in FIG. 4, a main valve generally designated 100 is connected upstream of the actuator 10 according to the invention. To avoid repetitions as regards the structure of the actuator 10, reference is made to what has already been set out with respect to FIGS. 2 and 3 above.

The main valve 100 comprises a basic housing 112a which has an inlet 114 as well as an outlet 116. Provided between said inlet 114 and said outlet 116 is a valve seat 118. The main valve 100 furthermore comprises an additional housing 112b which—together with the basic housing 112a—forms a housing 112 of the main valve 100.

In this case the additional housing 112b is formed such that portions of a valve body 120 operatively connected to the valve seat 118 are guided within said additional housing 112b and spring-biased by a spring 136. Moreover, the additional housing 112b includes a balancing chamber 138 having an outlet opening 142.

While the balancing chamber 138 is in fluid communication with the inlet 114 of the main valve 100 via a through bore 144 provided in the valve body 120, the outlet opening 142 is connected to the inlet 14 of the actuator 10 via a line 200 and the outlet 16 of the actuator 10 is connected to the outlet 116 of the main valve 100 via a line 202. In this case, the diameter of the through bore 44 in the valve body 20 of the actuator 10 is substantially smaller than the diameter of the through bore 144 in the valve body 120 of the main valve, and also the diameter of the outlet opening 142 in the housing 112b of the main valve 100 is substantially smaller than the through hole 142 between the first and second chambers 36, 38 of the actuator.

As the pressure in the inlet 16 of the actuator 10 is equal to the input pressure of the main valve 100, the actuator 10 has the same power as the main valve 100. Furthermore, as the flow is controlled by the main valve 100 and the cross-sections were suitably chosen, this clearly reduces the actuating force that needs to be exerted by the means for actuating the valve rod 22 of the actuator 10.

### REFERENCE NUMERALS

10 actuator
12 housing
12a basic housing
12b additional housing
14 inlet
16 outlet
18 valve seat
20 valve body
22 valve rod
24 seal
26 internal magnet
28 external magnet
30 frame
32 iron body
34 spring
36 spring
38 first chamber
40 second chamber
42 through hole between first and second actuator chambers
44 through bore in the valve body of said actuator
46 bore
48 electromagnet
100 main valve
112 housing
112a basic housing
112b additional housing
114 inlet
116 outlet
118 valve seat
120 valve body
136 spring
138 balancing chamber
142 outlet opening
144 through bore
200 line
202 line

1-12. (canceled)

13. An actuator (10) for controlling a fluid flow, comprising:
a basic housing (12a) having an inlet (14) and an outlet (16);
a valve seat (18) provided between said inlet and said outlet (14, 16) within said basic housing (12);
a valve body (20) which can be operatively connected to said valve seat (18);
a valve rod (22) for actuating said valve body (20),
means for actuating said valve rod (22);
a circumferential seal (24);
an additional housing (12b) is mounted on said basic housing (12a) in a fluid tight manner;
said basic and additional housings (12a, 12b) form a completely sealed housing (12) that is closed on all sides;
said circumferential seal (24) resides between said basic housing (12a) and said additional housing (12b);
said valve rod (22) resides completely within said sealed housing (12); and,
said means for actuating said valve rod (22) resides outside said sealed housing (12) and is operatively connected to said valve rod (22) in a non-contact manner.

14. The actuator (10) for controlling a fluid flow as claimed in claim 13, wherein said means for actuating said valve rod (22) includes a magnetic and/or an electromagnetic force.

15. The actuator (10) for controlling a fluid flow as claimed in claim 14 wherein said valve rod (22) includes an iron core (32) or a magnet (26) and said means for actuating said valve rod is an external magnet (28), said magnet displaceable relative to the sealed housing (12).

16. The actuator (10) for controlling a fluid flow as claimed in claim 14 wherein said valve rod (22) includes an iron core (32) or a magnet (26) and said means for actuating said valve rod is in the form of an electromagnet (48) that is firmly mounted on said housing (12).

17. The actuator (10) for controlling a fluid flow as claimed in claim 13 wherein said valve body (20) is operatively connected to a fluid-supplied drive, said fluid-supplied drive resides within said sealed housing.

18. The actuator (10) for controlling a fluid flow as claimed in claim 13, further comprising:
a positioner, said positioner includes a setpoint;
said valve body (20) position controlled by said positioner according to said set point;
said positioner resides within sealed housing (12);
working fluid is extracted from fluid at said valve inlet (14);
said set point is controlled through force transmission;
magnetic and/or electromagnetic means residing outside said sealed housing; and,
said magnetic and/or electromagnetic energy from said means located outside said sealed housing produces said force transmission.

19. Actuator (10) for controlling a fluid flow as claimed in claim 15, further comprising:
said valve rod (22) guided within said housing;
said valve body (20) partly guided within said housing;
said first and second chambers (38, 40) reside between said valve body (20) and said valve rod (22);
said first and second chambers (38, 40) reside in fluid communication with each other via a through hole (42);
a through bore (44) in said valve body (20);
said first chamber (38) adjacent said valve body (20) in fluid communication with said inlet (14) via said through bore (44) in said valve body (20);
a bore 46 in said second housing (12b);
said second chamber (40) surrounding said valve rod (22) in fluid communication with said outlet (16) via said bore (46); and,
actuation of said valve rod (22) opens and closes said through hole (42) between said first and second chambers (38, 40).

20. The actuator (10) for controlling a fluid flow according to claim 19, further comprising a spring element, and wherein said valve body (20) is guided within said housing under spring bias from said spring element (36).

21. The actuator (10) for controlling a fluid flow according to claim 19 wherein said through hole (42) is larger in diameter than said through bore (44).

22. The actuator (10) for controlling a fluid flow according to claim 13 further comprising a spring element (34) and wherein said valve rod (22) is guided within said housing under spring bias from said spring element (34).

23. Use of an actuator (10) according to claim 19 for controlling a main valve (100), wherein:
said main valve (100) comprises basic and additional housings (112a, 112b);
said basic housing (112a) has an inlet and an outlet (114, 116);
said basic housing includes a valve seat (118) disposed between said inlet and said outlet (114, 116);
said additional housing (112b) includes a valve body (120) operatively connected to said valve seat (118) and a balancing chamber (138) with an outlet opening (142);
a spring;
said valve body (120) is partly guided within said additional housing (112b) under spring bias;
a through bore in said valve body;
said balancing chamber (138) is in fluid communication with said inlet (114) of the main valve (100) via said through bore (144) in said valve body (120);
said outlet opening (142) of said balancing chamber (138) being in fluid communication with said inlet (14) of said actuator (10);
said outlet (16) of said actuator (10) being in fluid communication with said outlet (116) of said main valve (100); and,
said through bore (44) in said valve body (20) of said actuator (10) as well as said through hole (42) between said first and second chambers (38, 40) of said actuator (10) are smaller in diameter than said through bore (144) in said valve body (120) of said main valve (100) and said outlet opening (142) of said balancing chamber (138) of said main valve (100).
